(19) United States
(12) Patent Application Publication
(10) Pub. No.: US 2007/0273290 A1
(43) Pub. Date: Nov. 29, 2007

(54) Integrated Modular Light Unit

(76) Inventors: Ian Ashdown, West Vancouver (CA); Paul Jungwirth, Burnaby (CA); Shane P. Robinson, Gibsons (CA); Philippe Schick, Vancouver (CA); Ingo Speier, Vancouver (CA); Allan Brent York, Langley (CA)

Correspondence Address: KING & SPALDING LLP, 1180 PEACHTREE STREET, ATLANTA, GA, 30309-3521, US

(21) Appl. No.: 10/568,996

(22) PCT Filed: Nov. 29, 2005
(86) PCT No.: PCT/CA05/01792

§ 371 Date: Jan. 30, 2007

Related U.S. Application Data
(60) Provisional application No. 60/631,466, filed on Nov. 29, 2004.
(60) Provisional application No. 60/668,786, filed on Apr. 5, 2005.

(51) Int. Cl. H01J 7/24

(52) U.S. Cl. 315/113

(57) ABSTRACT

The present invention provides an integrated self-contained lighting module which can be used on its own, or in conjunction with other modules to produce white light, or light of any other colour within the colour spectrum. Each module comprises one or more light-emitting elements, a drive and control system, a feedback system, thermal management system, optical system, and optionally a communication system enabling communication between modules and/or other control systems. Depending on the configuration, the lighting module can operate autonomously or its functionality can be determined based on either or both internal signals and externally received signals.

### FIELD OF THE INVENTION

The present invention pertains to the field of lighting systems and in particular to an integrated modular light-emitting device lighting unit wherein the modular lighting unit is capable of dimming and control of light colour and correlated colour temperature.

### BACKGROUND

Having regard to general lighting, the first Edison base type incandescent style lamps and all of their derivatives have remained relatively unchanged through to the present day. While many incremental technologies have led to the development of longer lived, higher efficiency, and more consistent light sources throughout many decades, the basic form that gave rise to the construction of a luminaire has remained relatively stable.

Other lamp forms are commonly seen in the lighting industry. For example, fluorescent lamps can provide elongated cylindrical light sources. In the case of high intensity discharge lamps, their shapes are often similar to the typical incandescent lamp with glass bulb envelopes and metal screw type bases that mate to their respective electrical sockets. These forms of lighting devices are ubiquitous and pervade the general field of lighting that represents a large global industry.

These general lamp forms are well suited to the tasks of supporting the respective general light emitting structure or process that is present within each of their glass bulb envelopes. In particular these lamp forms can provide a protective mechanical surrounding that prevents either the escape of internal gases and/or the ingress of external gases that could contaminate the interior assembly of the lamp, thereby disrupting their functionality. Additionally, these forms can provide a stable thermal environment that contains the internal gas and maintains temperatures at levels conducive to light output. They can also provide a reliable and standardized form factor for the provision of electrical contacts at the base or ends of a lamp, for example they can mate to industry standard socket forms. The Edison screw base is the most common form for this interface since it provides a mechanical linkage that supports the entire bulb while providing a reliable and redundant metallic electrical contact at many points along the screw shell. These general lamp forms can additionally provide a convenient optical shape for light emission that is suited to the reflector geometry and optics of the luminaire. The oldest and simplest forms of lamps provide a roughly spherical light emission pattern from the filament within a glass envelope. As lamp types evolved over time, the bulb formats gave rise to reflectorized types of lamps that contain an integral reflector added inside or outside the bulb to generate a “beam” of light, for example. Finally these general lamp forms can provide a convenient standard quantity of light that is usually suited to the illumination task. Over decades lamps have remained relatively unchanged and certain standard sizes and wattages have emerged that are often consistent, even from manufacturer to manufacturer. Examples include the common 60 Watt incandescent A-style lamp, the 40 Watt T12 fluorescent lamp and the 250 Watt high pressure sodium lamp, wherein each of these devices has evolved to suit specific types of luminaires, applications and/or markets.

With the emergence of competitive light-emitting diode (LED) technologies that already surpass the performance of almost all incandescent lamps in both electrical efficiency and life expectancy, industry forecasts predict that a performance of 150 lumens per watt and even 200 lumens per watt are possible from LEDs. These figures easily surpass today's conventional white light sources that generate light with less than 100 lumens per watt. In view of the fact that the single greatest cost of ownership of any given lamp is its electrical consumption over its life, the LED can provide a strong economic case.

One of the key challenges for LEDs to achieve wide market adoption is the fact that they are significantly more variable in production and do not yet exhibit a standardized form or structure that is conducive to general illumination applications. For example, raw light output from a group of LED chips grown on the same wafer manufactured by the same equipment may have as much as approximately a 3:1 variation in their luminous flux output over the same wafer. This fact gives rise to a binning strategy which is commonly used in the industry, whereby LEDs are individually tested and binned into categories of luminous flux output that represent approximately 30% intervals. Likewise, forward voltage, dominant wavelength and beam spread may be other factors that are considered during the binning process.

Structurally, LEDs are often packaged into single chip packages that are derived from the needs of the indicator lamp market. Many of these are designed to be soldered to circuit boards and are designed to employ electronics manufacturing equipment and processes. The optics associated with these packages are often compromised in order to provide a specific or desired beam pattern, resulting in optical efficiencies of less than approximately 60%. For thermal regulation, many of these LED packages rely on a metallic frame acting as a heat sink for cooling, although some of the more recent LED packages are starting to employ a thermal contact pad that is in intimate contact with a substrate for efficient heat transfer.

Over the years there have been a number of illumination apparatuses that have been designed using light emitting diodes. In particular European Patent No. 1,416,219 discloses an LED illumination apparatus with a connector and drive circuit. The connector is coupled to an insertable and removable card-type LED illumination source, which includes multiple LEDs that have been mounted on one surface of a substrate. The lighting drive circuit is electrically connected to the card-type LED illumination source by way of this connector. The card-type LED illumination source preferably includes a metal base substrate and the multiple LEDs have been mounted on one side of this metal base substrate. The back surface of the metal base substrate, upon which no LEDs have been mounted, is in thermal contact with a portion of the illumination apparatus. A feeder terminal to be electrically connected to the connector is provided on the surface of the metal base substrate on which the LEDs are provided, thereby enabling electrical excitation of the LEDs mounted on the card-type element.

This European patent discloses several features of a stand-alone lighting apparatus; however it does not provide a means for enabling colour control, intensity control, thermal control or any other control of the lighting apparatus beyond straight electrical drive of the LEDs. Furthermore, this stand-alone lighting apparatus is not enabled to interact or communicate with other lighting apparatuses and therefore functions autonomously.

U.S. Pat. No. 6,617,795 discloses a multichip light-emitting diode package having a support member, at least two light-emitting diode chips disposed on the support member, at least one sensor disposed on the support member for reporting quantitative colourimetric information to a controller relating to the light output of the light-emitting diodes, and a signal processing circuit which includes an analog-to-digital converter logic circuit, disposed on the support member for converting the analog signal output produced by the sensors to a digital signal output. The issue of protecting LEDs from overheating is introduced and it is proposed that the use of temperature sensors can provide a means to monitor this parameter. However, this apparatus does not include a proactive means for heat removal from the device or a means for heat regulation within this LED package. Furthermore, while this package allows for connection to some type of external power supply, control or limiting of the power transmitted to the LEDs is not provided and therefore this apparatus may suffer from thermal and control limitations.

A modular warning signal light system is disclosed in U.S. Pat. No. 6,462,669. This warning signal light system comprises at least one support having at least one module receiving port arranged to receive the support engagement member of another module in a removable manner. Each module includes at least one visible side that has at least one light emitting diode light source engaged thereto. The light emitting diode light source, module and support are all in independent electrical communication with a controller. The controller is constructed and arranged to selectively activate at least one support, at least one module, at least one light emitting diode light source, and any combinations thereof to create at least one warning light signal. This system does not however include any means for heat management and there is no mention of any data collection during operation in order to control a variety of properties relating to the functionality of the light system and therefore this system may suffer from thermal and control limitations.

U.S. Pat. No. 6,331,063 discloses an LED luminaire formed in a manner that a plurality of LED chips are disposed three-dimensionally on a MID (moulded interconnection device) substrate in a rectangular plate shape. The mounting of three LED chips on the bottom face of respective dents provided lengthwise and crosswise on one surface of the MID substrate is disclosed. The LED chips are selected from at least two types that are mutually different in luminous colour, and it is disclosed as being desirable that three types, namely red, blue, and green coloured LEDs are used. In this manner optional light distribution characteristics may be thereby obtainable depending on the configuration of the substrate and the LEDs thereon. In this manner different colours such as white and daylight colours of incandescent and fluorescent lamps are enabled by mixing the luminous colours of the respective LED chips. There is however, no mention of a self-contained modular illumination unit designed to interact with other modular illumination units for the creation of light, and there is also no disclosure relating to a modular design of the lighting units.

In addition a smart light emitting diode cluster and system is disclosed in U.S. Pat. No. 6,208,073. The smart cluster and system includes a central processing unit (CPU) and a plurality of LED cluster strings, each comprising an LED cluster connected in series. Each LED cluster includes an LED drive circuit and a plurality of LEDs, wherein the CPU receives an external input image signal, and then the desired control signal and image data are sent to the LED cluster strings by appropriate processing. The control signal is used to switch the LEDs in the cluster in order to generate a desired image and related colour variation. Subsequently, the control signal and image data are transferred to the next LED cluster by the LED drive circuit. In this manner, the control signal and image data are progressively transferred from the first to the last cluster so that an entire image with colour variation can be displayed by all of the LED clusters in the system. There is, however, no reference to heat regulation or operational feedback for the individual LED clusters and therefore this system may suffer from thermal and control limitations.

U.S. Pat. No. 6,441,558 discloses a luminaire light control system comprising a controller system coupled to a power supply stage. The controller is configured to provide control signals to the power supply so as to maintain the DC current signal at a desired level for producing the required light output. There is further disclosed the use of temperature and light sensors to provide feedback regarding the light emitting devices, in order for the controller to maintain a desired luminous flux output for each of the LEDs. There is disclosed a complete luminaire system however there is no mention of modular units for integration and forming of a luminaire system. Furthermore, although this system is intended to form a complete system, there is no disclosure of any method or means for heat management and therefore this system may suffer from the heat regulation problems.

A system for controlling the luminous intensity of light emitting diodes is disclosed in U.S. Pat. No. 5,783,909. The invention comprises a sensor for measuring the luminous intensity of the LEDs in addition to a power supply capable of providing a switched electrical supply to the LEDs. The switched power supply uses a pulsing strategy to modulate the output to the LEDs so as to maintain a desired luminous intensity. This system however does not include a means for dissipating heat from the LEDs or any optics for colour mixing, collimation or re-direction or any modularity of the lighting device. This system may therefore suffer from thermal problems in addition to problems with the generation of substantially uniform illumination.

U.S. Pat. No. 6,741,351 discloses a luminaire with a means for maintaining a desired colour balance from an array of red, green, and blue LEDs. Photodiodes are used to intercept a sampling of the light emitted from the LEDs. A method for testing the luminous flux output of each different colour is disclosed, using a pulsing approach where LEDs are selectively turned on and off, thereby enabling the light sensor to measure each LED separately. There is however no disclosure relating to any heat management, heat removal, or any notion of modularity of the lighting unit for use in a larger lighting system. This system may therefore suffer from thermal regulation issues.

It is clear that the evolution of LED based light sources into consistent, user-friendly modular devices for general illumination has not yet occurred. The prior art discloses efforts to address some of the difficulties associated with the use of light-emitting devices in lighting applications such as control over intensity and chromaticity and removal of heat from LEDs. However, an integrated solution to satisfy general lighting requirements while exploiting the benefits of light-emitting devices is presently not available. Therefore there is a need for a new integrated modular light-emitting device lighting unit that can function as a single unit or in combination with other modular units and maintain a given intensity and chromaticity while utilizing the efficacy of the light-emitting devices and their lifetime, thereby providing designers flexibility for the design of luminaires based on light-emitting devices.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an integrated modular lighting unit. In accordance with an aspect of the present invention, there is provided an integrated lighting module comprising: one or more light-emitting elements for generating illumination; an optical system optically coupled to the one or more light-emitting elements for manipulating the illumination; a feedback system for collecting information representative of operational characteristics of the one or more light-emitting elements, said feedback system generating one or more signals representative of said information; a thermal management system in thermal contact with the one or more light-emitting elements, said thermal management system for conducting heat away from the one or more light-emitting elements; a drive and control system receiving the one or more signals from the feedback system, said drive and control system regulating input power and generating and sending control signals to the one or more light-emitting elements, said control signals generated based on predetermined control parameters and said one or more signals.

In accordance with another aspect of the present invention, there is provided a networked lighting system comprising: two or more integrated lighting modules, each module including; one or more light-emitting elements for generating illumination; an optical system optically coupled to the one or more light-emitting elements for manipulating the illumination; a feedback system for collecting information representative of operational characteristics of the one or more light-emitting elements, said feedback system generating one or more signals representative of said information; a thermal management system in thermal contact with the one or more light-emitting elements, said thermal management system for conducting heat away from the one or more light-emitting elements; a drive and control system receiving the one or more signals from the feedback system, said drive and control system regulating input power and generating and sending control signals to the one or more light-emitting elements, said control signals generated based on predetermined control parameters and said one or more signals; and a communication system operatively connected to the drive and control system, said communication system enabling communication between the two or more integrated lighting modules.

### BRIEF DESCRIPTION OF THE FIGURES

FIG. 1 is a diagram of the components of the integrated lighting module according to one embodiment of the present invention.

FIG. 2 is a diagram of the functional blocks of drive and control system showing the division between drive and control of the integrated lighting module according to one embodiment of the present invention.

FIGS. 3A to 3G illustrate configurations of the driver sub-module of the drive and control system according to embodiment of the present invention.

FIG. 4 is a cross sectional view of a cloverleaf compound parabolic concentrator (CPC) optical element of the optical system according to one embodiment of the present invention.

FIG. 5 is a cross sectional view of a parabolic reflector optical element of the optical system according to one embodiment of the present invention.

FIG. 6 is a cross sectional view of a segmented parabolic reflector optical element of the optical system according to one embodiment of the present invention.

FIG. 7 is a cross sectional view of an optical element of the optical system comprising a parabolic mirror and a long pass filter arrangement according to one embodiment of the present invention.

FIG. 8 illustrates a lighting unit comprising a multi module QFP (“Quad Flat Pack”) package incorporating heat pipes according to one embodiment of the present invention.

FIG. 9 illustrates an integrated modular lighting unit torchiere according to another embodiment of the present invention.

FIG. 10 illustrates an integrated module lighting unit luminaire according to another embodiment of the present invention.

FIG. 11 illustrates a lighting unit comprising multiple sub-modules of light-emitting elements according to another embodiment of the present invention.

FIG. 12 illustrates lighting unit with components in a stacked configuration according to another embodiment of the present invention.

FIG. 13 illustrates a lighting module according to one embodiment of the present invention.

FIG. 14 illustrates a lighting module according to another embodiment of the present invention.

FIG. 15 illustrates the lighting module according to FIG. 14 wherein the optical system has been separated from the remainder of the lighting module.

FIG. 16 is a cross sectional view of a lighting module integrated within a housing according to one embodiment of the present invention.

FIG. 17 illustrates the lighting module according to one embodiment of the present invention.

FIG. 18 illustrates the optical system of the lighting module according to one embodiment of the present invention.

FIG. 19 illustrates a thermal management system according to one embodiment of the present invention.

### DETAILED DESCRIPTION OF THE INVENTION

Definitions

The term “light-emitting element” is used to define any device that emits radiation in any region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or any other similar light-emitting devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

As used herein, the term “about” refers to a ±10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an integrated self-contained lighting module that can be used on its own or in conjunction with other modules to produce white light, or light of any other colour within the available colour gamut of light-emitting elements associated therewith. Each module comprises one or more light-emitting elements, a drive and control system, a feedback system, thermal management system, optical system, and optionally a communication system enabling communication between modules and/or other control systems. Depending on the configuration, the lighting module can operate autonomously or its functionality can be determined based on both internal signals and externally received signals, solely externally received signals or solely internal signals.

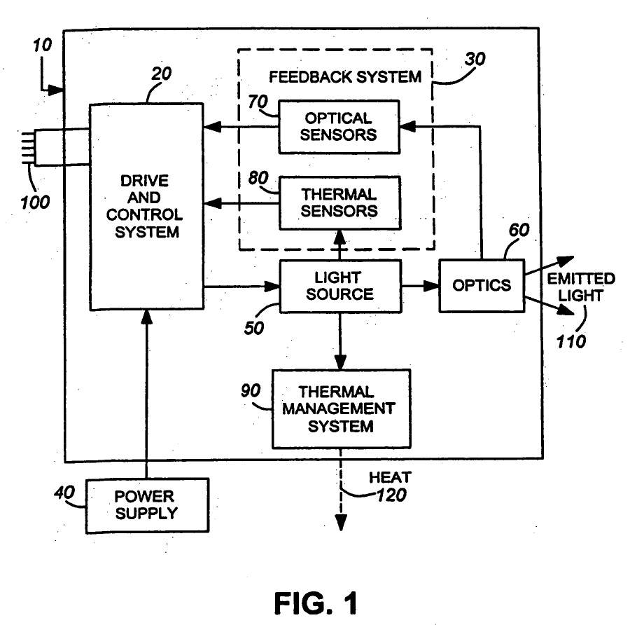

FIG. 1 illustrates a diagram of the lighting module and its components. The lighting module 10 includes a light source 50 comprising one or more light-emitting elements for generation of illumination. An external power source 40 provides power to the lighting module 10 wherein this provided power is regulated by the drive and control system 20. This power regulation can include the conversion of the supplied external power to a desired input power level that can be determined based on characteristics of the light-emitting elements within the module, for example. In addition, to power conversion, the drive and control system provides a means for controlling the transmission of control signals to the light-emitting elements thereby controlling their activation. The drive and control system can receive input data from within the lighting module 10, for example from the feedback system 30 and may receive external input data from other lighting modules or other controlling devices. An optional communication port 100 can provide the drive and control system with the capability for both input and output of signals to and from the module, respectively.

The feedback system 30 within the module 10 can comprise one or more forms of detectors or other similar devices. For example an optical sensor 70 and/or thermal sensor 80 can be integrated into the feedback system. The optical sensor 70 can detect and provide information to the drive and control system that can relate to the luminous flux and chromaticity of the illumination generated by the light-emitting elements and additionally can relate to ambient daylight readings, for example. This form of information can enable the drive and control system to modify the activation of the light-emitting elements within the module in order that a desired illumination is generated. A thermal sensor 80 can detect the temperature of the substrate on which the light-emitting elements are mounted, the temperature of one of or each of the light-emitting elements and the temperature within the lighting module itself, for example. This temperature information can be transferred to the drive and control system thereby enabling the modification of the activation of the light-emitting elements in order to reduce thermal damage of the light-emitting elements due to overheating, for example, thereby improving the longevity thereof.

The thermal management system 90 provides a system for transferring heat generated by the light source 50 to a heat sink or other heat dissipation device. The thermal management system comprises intimate thermal contact with the light-emitting elements and provides a predefined thermal path for the heat to be transferred away from the light-emitting elements. Optionally, the thermal management system may further provide a means for transferring heat away from the drive and control system.

The optical system 60 receives the illumination created by the light source 50 and provides a means for efficient optical manipulation of this illumination. The optical system can for example provide a means for the collection and/or collimation of luminous flux 110 emitted by the light source 50 and can provide colour mixing of the emission of multiple light-emitting elements. The optical system can also provide control over the spatial distribution of light emanating from the lighting module. In addition, the optical system can provide a means for directing a fraction of the illumination to the optical sensor 70 in order to enable feedback signals to be generated which are representative of the characteristics of the illumination generated by the lighting module.

In one embodiment the drive and control system 20 of a lighting module can operate independently of other external lighting modules and an external control system.

In another embodiment, the drive and control system 20 can receive input data from other lighting modules or an external control system via an optional communications port 100, wherein this data can include status signals, lighting signals, feedback information and operational commands, for example. The drive and control system 20 can equally transmit this externally received data or internally collected or generated data to other lighting modules or an external control system. This transmission of information can be enabled by the optional communication port 100 coupled to the drive and control system.

Light Source

The light source comprises one or more light-emitting elements that can be selected to provide a predetermined colour of light. The number, type and colour of the light-emitting elements within the light source can provide a means for achieving high luminous efficiency, a high Colour Rendering Index (CRI), and a large colour gamut. The light-emitting elements can additionally be positioned with respect to the optical system to achieve optimal colour mixing and collimation efficiency. The light-emitting elements can be manufactured using either organic material, for example OLEDs or PLEDs or inorganic material, for example semiconductor LEDs. The light-emitting elements can be primary light-emitting elements that can emit colours including blue, green, red or any other colour. The light-emitting elements can optionally be secondary light-emitting elements, which convert the emission of a primary source into one or more monochromatic wavelengths, polychromatic wavelengths or broadband emissions, for example in the cases of blue or UV pumped phosphor coated white LEDs, photon recycling semiconductor LEDs or nanocrystal coated LEDs. Additionally a combination of primary and/or secondary light-emitting elements can be employed. As would be readily understood by a worker skilled in the art, the one or more light-emitting elements can be mounted for example on a PCB (printed circuit board), a MCPCB (metal core PCB), a metallized ceramic substrate or a dielectrically coated metal substrate that carries traces and connection pads. The light-emitting elements can be in unpackaged form such as in a die format or may be packaged parts such as LED packages or may be packaged with other components including drive circuitry, feedback circuitry, optics and control circuitry.

In one embodiment, an array of light-emitting elements having spectral outputs centred around wavelengths corresponding to the colours red, green and blue can be selected, for example. Optionally, light-emitting elements of other spectral output can additionally be incorporated into the array, for example light-emitting elements radiating at the red, green, blue and amber wavelength regions may be configured as the light source or optionally may include one or more light-emitting elements radiating at the cyan wavelength region. The selection of light-emitting elements for the light source can be directly related to the desired colour gamut and/or the desired maximum luminous flux and colour rendering index to be created by the lighting module.

In another embodiment of the present invention, a plurality of light-emitting elements are combined in an additive manner such that any combination of monochromatic, polychromatic and/or broadband sources is possible. Such a combination of light-emitting elements includes a combination of red, green and blue (RGB) light-emitting elements, red, green, blue and amber (RGBA) light-emitting elements and combinations of said RGB and RGBA together with white light-emitting elements. The combination of both primary and secondary light-emitting elements in an additive manner is possible. Furthermore, the combination of monochromatic sources with polychromatic and broadband sources such as light-emitting elements generating light having colours RGB and white, GB (green and blue) and white, A (amber) and white, RA (red and amber) and white, and RGBA and white is also possible. The number, type and colour of the multiple light-emitting elements can be selected depending on the lighting application and to satisfy lighting requirements in terms of a desired luminous efficiency and/or CRI.

In one embodiment, the light-emitting elements may also be selected on the basis of similar temperature dependencies, for example phosphor-coated white LEDs, green LEDs, and blue LEDs that are based on a common InGaN semiconductor technology. This selection criteria of light-emitting elements for the light source may provide for ease of temperature compensation during control of these light-emitting elements.

In one embodiment, multiple light-emitting elements can be connected electrically in a plurality of configurations. For example, the light-emitting elements can be connected in series or parallel configurations or combinations of both. In one embodiment of the present invention, two or more light-emitting elements are connected in series as linear strings, wherein a string may comprise light-emitting elements of the same colour bin, or a combination of colours or colour bins, for example. In this embodiment of the present invention, all of the light-emitting elements in a string are electrically connected such that they are powered as a group by the drive and control system of the lighting module.

In another embodiment of the present invention, the light-emitting elements are grouped in series as pairs of linear strings, wherein a string may comprise light-emitting elements from a combination of colour bins of the same generic colour, for example blue, wherein the dominant wavelengths of the light-emitting elements for one of the pair of linear strings are equal to or greater than a predetermined wavelength and the dominant wavelengths of the light-emitting elements of the other string of the pair of strings are equal to or less than this predetermined wavelength. Therefore, by adjusting the relative drive currents to each string of a pair of strings of a given colour, it can be possible to dynamically adjust the effective dominant wavelength of that given colour for the light module. In this manner a plurality of lighting modules forming a lighting network can exhibit the same colour gamut and generate light of the same chromaticity in response to a command for the entire lighting network.

In another embodiment of the present invention, light-emitting elements are electrically connected in order that each individual light-emitting element can be individually managed and controlled by the drive and control system of the lighting module. For example, a string of light-emitting elements can be wired such that some light-emitting elements can be bypassed either partially, or completely to allow this individual control of each light-emitting element independent of one another.

Drive and Control System

The integrated drive and control system can accept power from an external power source, regulate it and distribute it to the light-emitting elements. The drive and control system can provide power control in response to signals received from the feedback system, for example optical and thermal feedback signals in order to maintain a set colour balance and light output within predefined limits. The performance of the drive and control system can be configured to have a high efficiency and smooth response in order to maintain a stable load on the external power supply, while at the same time enabling the rapid switching of the activation of the light-emitting elements and changes in power settings without creating excessive current spikes or visible fluctuations in the light output. In addition, the drive and control system can be flexible in order to accommodate different types of light-emitting elements in the lighting module with different forward voltages and/or current requirements without the need for binning thereof, as is presently performed in the prior art.

The drive and control system provides a means to control the supply of power to the multiple light-emitting elements. In one embodiment of the present invention, the drive and control system uses digital switching to achieve this form of control. The power supplied to the light-emitting elements can be digitally switched using techniques such as pulse width modulation (PWM), pulse code modulation (PCM) or any other similar approach known in the art. In this manner the control of the illumination generated by each of the light-emitting elements or strings thereof can be controlled, enabling the creation of a desired illumination effect such as dimming, strobing, or other visible or invisible effects, for example optical communication signals.

In one embodiment of the present invention, light-emitting elements connected in series can be powered by a single external power supply, wherein all light-emitting elements in the series can be controlled as a unit, by the drive and control system.

The drive and control system can be configured to activate the light-emitting elements at a previously determined frequency, wherein this can be an optimal frequency. In one embodiment, the selected switching frequency may be selected in a manner that one or more of the following characteristics are satisfied, for example the switching frequency is sufficiently high in order that visual flicker is not perceptible for example greater than about 60 Hz, audible resonances of the power components are beyond the range of human hearing for example greater than about 16 kHz, and thermal stressing of the light-emitting elements can be minimized by ensuring that the selected switching period is substantially less than the thermal time constant of for example the LED die, which is typically on the order of ten milliseconds resulting in a desired switching frequency greater than about 1 kHz.

In another embodiment of the present invention, the junction temperature of the light-emitting element for example an LED die, is monitored and the maximum slope of change in drive current is limited in order to limit the maximum change in junction temperature over time, thereby limiting thermal stressing of the light-emitting element that may otherwise lead to premature device failure due to for example wire debonding or accelerated device aging due to non-radiative dislocation growth.

In one embodiment of the present invention, the drive and control system uses a microcontroller or a field programmable gate array (FPGA). The microcontroller or FPGA array can receive signals from the feedback system, relating to operational conditions of the lighting module, for example optical feedback, temperature feedback and can additionally receive external control signals in order to generate the digital switching signals to be transmitted to each light-emitting element or string thereof. In this manner, the intensity levels of the light-emitting elements can be determined based on the received information thereby enabling the generation of a desired colour and intensity of illumination.

Furthermore, in one embodiment each light-emitting element or string thereof can be connected to a high-efficiency switching converter in order to provide constant current output from a common voltage supply rail. This can be configured to provide a constant DC current, or a constant peak current in the case where the light-emitting elements are to be digitally switched at varying duty cycles. In this manner, strings having varying voltage drops across a string can be appropriately driven using the same voltage supply since each string would only be provided the voltage required to drive it at a predetermined current level. In one embodiment of the present invention, a buck converter associated with a particular light-emitting element or string thereof can be configured to regulate the power supplied thereto depending on the voltage drop across the light-emitting element or string and the specific voltage supplied by the common voltage supply rail. As would be readily understood by a worker skilled in the art, any form of switch-mode DC-DC converter can be used, for example a fly-back, buck, boost, or buck-boost converter.

In another embodiment of the present invention the drive current supplied to the light-emitting elements is reduced when the lighting module is dimmed. For example, the drive current may be 100 percent of maximum over the range of 50 percent to 100 percent of maximum luminous flux output, and 50 percent of maximum for luminous flux output less than 50 percent of the maximum value. A particular advantage of this configuration is that the duty factor of a PWM or PCM drive signal is increased for low light levels. This configuration can relax the timing requirements for example sampling of the luminous flux output of an optical sensor or the forward voltage by a voltage sensor. Another advantage is that the drive current harmonics due to a binary pulse wave with a small duty factor can be reduced, thereby alleviating potential problems with power line harmonics and radio-frequency emissions.

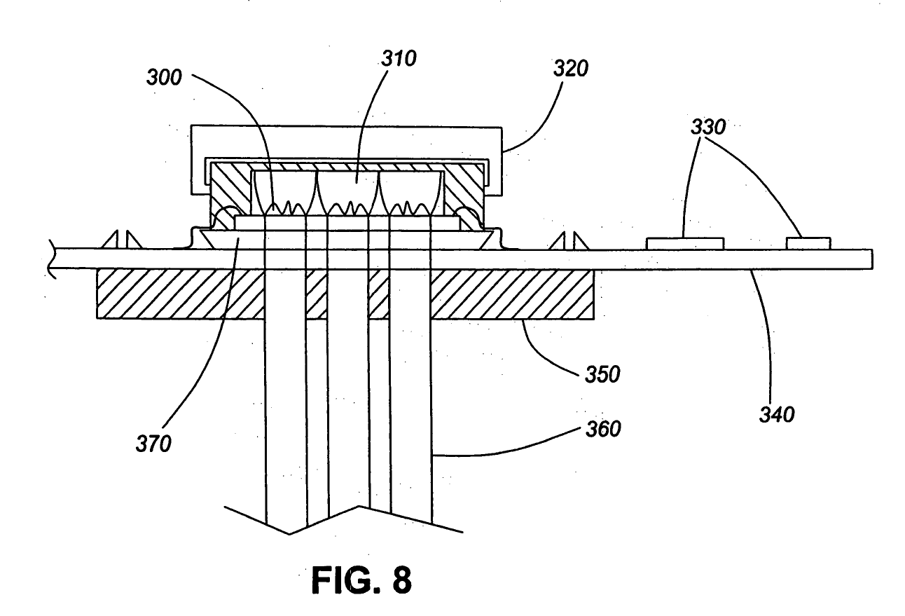

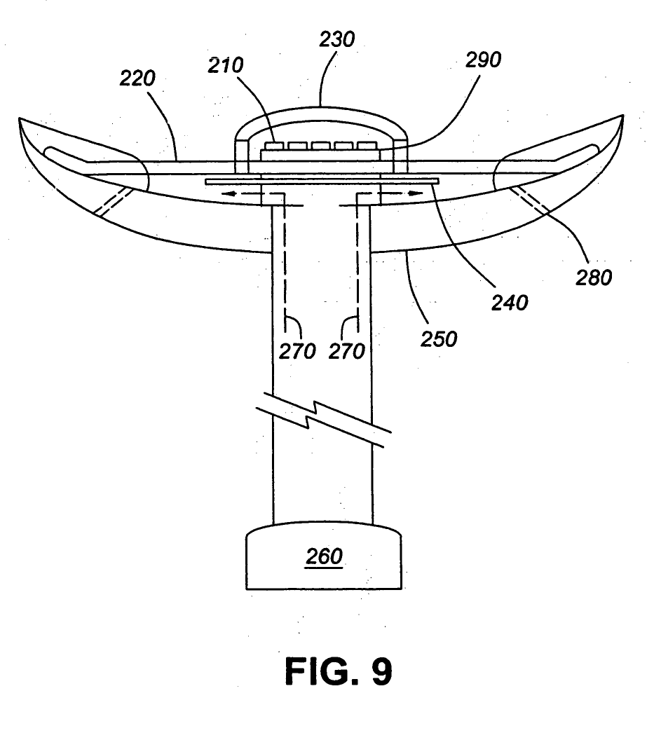

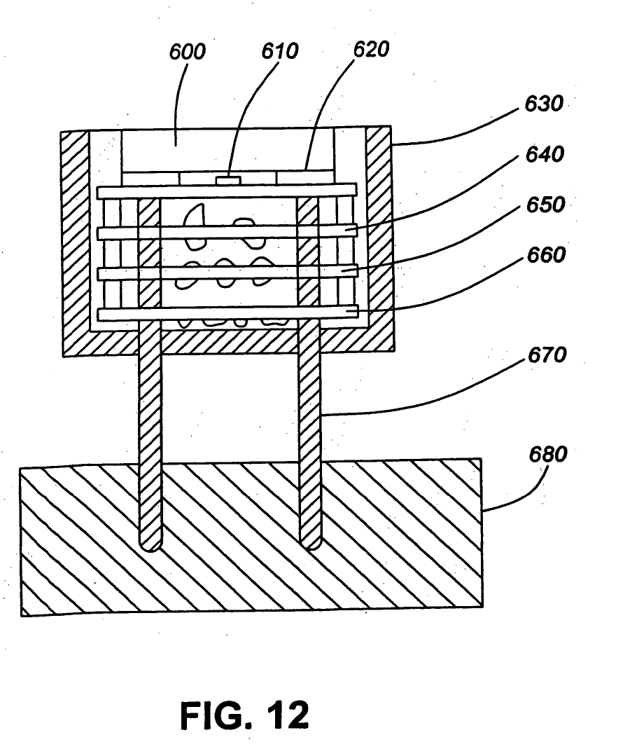

In one embodiment of the present invention the drive and control system can be integrated with other electronics on the same printed circuit board (PCB) which can further include the light-emitting elements, in order to provide a small form factor design, as illustrated in FIG. 8 or 9 for example. Alternatively, the drive and control system can be placed on a separate dedicated PCB adjacent to a PCB that holds the other electronics and light-emitting elements, with these boards being electrically and mechanically interconnected to achieve a different form factor, as illustrated in FIG. 12, for example. A particular advantage of this using separate dedicated PCBs is that the drive and control system can be thermally isolated from the heat-generating light-emitting elements, thereby reducing device temperatures and improving system reliability and the environmental operating temperature.

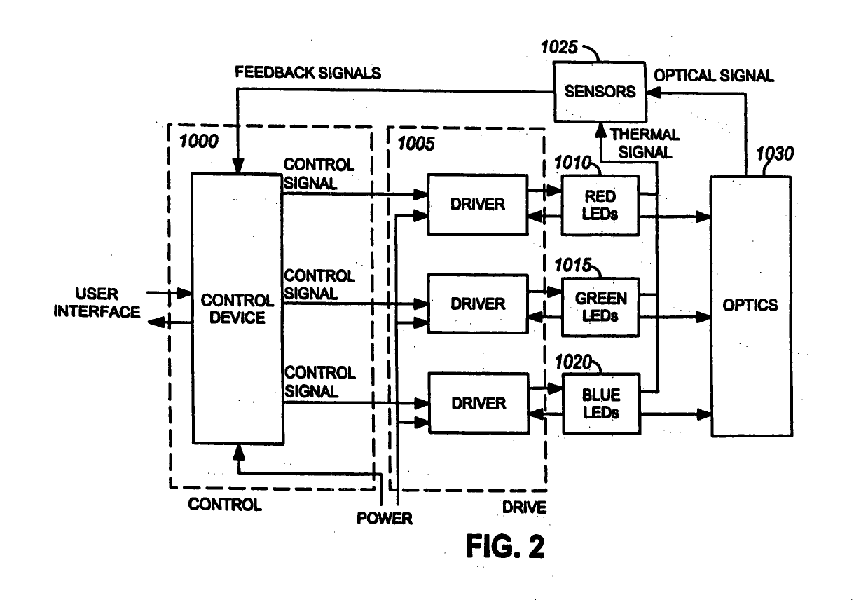

In one embodiment the drive and control system can be separated into two separate functional blocks as shown in FIG. 2 wherein the driver module 1000 accepts input from the control module 1005 and interfaces to the light-emitting elements, for example red LEDs 1010, green LEDs 1015 and blue LEDs 1020 to maintain a drive level based upon that input. The multiple colour LEDs 1010, 1015 and 1020, driver module 1005, control module 1000 and sensor module 1025 can be configured as shown in FIG. 2. The sensor module forms a portion of the feedback system 30 as illustrated in FIG. 1. The operating characteristics of the LEDs 1010, 1015, 1020 can be monitored by the sensor module 1025 which detects their light output, operating temperature, or other information, and therefore the sensor module may include one or more optical sensors, one or more temperature sensors, and any other required sensor depending on the desired information to be collected.

In one embodiment, some light emitted by the LEDs 1010, 1015, 1020 may be sent directly to the optical sensors in the sensor module 1025 without passing through the optics 1030. In an alternate embodiment an optical signal representative of the characteristics of the light generated by the LEDs may be indirectly measured within the optics 1030 as light first passes through the optics. Thus in one embodiment of the system which uses multiple colours of LEDs, for example red, green, and blue, the signal detected by the optical sensors can be representative of the mixed light from all the LEDs.

In the embodiment illustrated in FIG. 2, the control module 1000 can send a signal or signals to the driver module 1005 to drive the red LEDs 1010, green LEDs 1015 and blue LEDs 1020 to a desired level such that the combined output from these LEDs is maintained at a desired intensity and chromaticity set point, wherein this signal or signals can be based on the one or more feedback signals from the sensor module 1025. For example, this set point may be stored internally in the control module, or the set point may be adjusted based on user input via a user interface, for example. In one embodiment, the control module can act autonomously to maintain white light output from the lighting module, such that this light output lies substantially on the black body locus. Through the active monitoring of the mixed light output generated by the lighting module through the use of the feedback system, the control module can evaluate and send control signals to the driver module in order to maintain the desired light output.

In one embodiment, in response to inputs from a user interface, the control module can be made to adjust the CCT of the white output light. In this case, the user does not have any direct control over the output of the light-emitting elements as the control module can perform appropriate calculations in order to actively adjust the light-emitting element drive current levels and hence the colour balance can be maintained at a desired white point. This procedure can greatly simplify adjustments of the CCT by the user and allow for a basic user interface, such as a wall dimmer.

In another embodiment, a user can increase or decrease the overall light output intensity of the lighting module while allowing the control module to maintain the proper ratios of intensity between the different colours of light-emitting elements, and hence maintain substantially the same white point even while dimming. In another embodiment, the control module can be configured to maintain any point or set of points within the colour gamut of the light-emitting elements of the light source. In another embodiment, a sophisticated user interface may provide a user with the ability to select any of the colours in the colour gamut, wherein the control module can maintain this selected colour through the active data received from the feedback system.

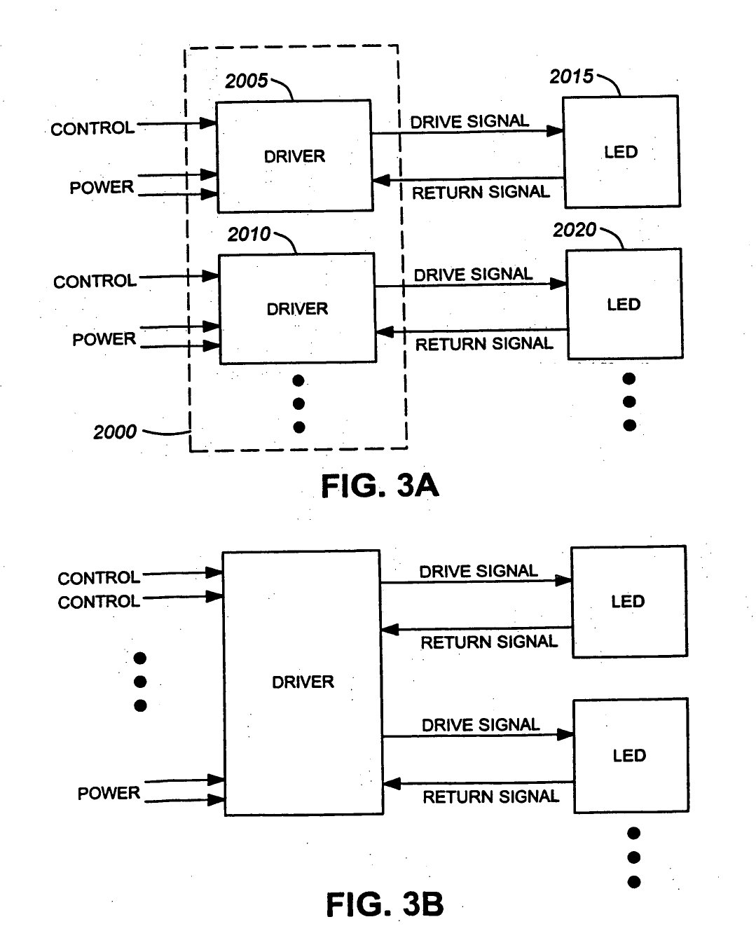

FIGS. 3A to 3G illustrate how a driver module can regulate power to the light-emitting elements, for example LEDs. As is known, LEDs are constant current devices, and in one embodiment shown in FIG. 3A, the driver module 2000 and in particular a driver 2005 or 2010 sends a drive signal to the LED or LED string 2015 or 2020 and receives a return signal back therefrom, thereby allowing for closed loop current control of the LEDs. In one embodiment, the drive signal and return signal are the drive and return currents supplied to the LEDs. Within a driver, the level of current supplied to the LED can be monitored to ensure that for a given control input from the control module, a fixed current level is maintained through the LED regardless of variations in forward voltage due to temperature, aging, or other degradation effects of the LED. In one embodiment, a driver includes a current sense resistor in order to allow the drive current to be monitored. In one embodiment, as illustrated in FIG. 3A, one driver accepts one control input and drives one LED or one string of LEDs, and multiple drivers are used for multiple LEDs or multiple strings of LEDs. This configuration of the drive module can allow for example one driver to be connected to LEDs of one colour, in order that one control input can enable the setting of all of the LEDs of a single colour to the same level without affecting any other colours of LEDs or strings of LEDs. The driver module configuration as illustrated in FIG. 3A can remain essentially the same regardless of a difference in forward voltage requirements between different LED strings. Alternately, as illustrated in FIG. 3B, a single driver with multiple outputs can be used to drive multiple LEDs or multiple strings of LEDs based on multiple control inputs.

FIGS. 3C to 3G show alternate configurations of information transfer between a driver and the LED or string of LEDs that it controls, wherein these configurations enable closed loop current control. In FIG. 3C the driver can send a drive signal to the LED and receive an associated return signal from the LED and further receive a sense signal from the LED. The sense signal can indicate for example the voltage across one or more of the LEDs in the string, wherein this can be used to monitor the current level. In an alternate embodiment as illustrated in FIG. 3D, the return path from the LED to the driver can be eliminated by connecting the LED to ground. In a further embodiment as illustrated in FIG. 3E, the sense signal can be eliminated when a current sensing device is integrated within the driver. FIG. 3F illustrates an embodiment, wherein the drive signal can be eliminated by connecting the LEDs directly to the input power supply, however this configuration requires a return signal for the driver to maintain the current at a desired level which can be performed using internal current sensing and limiting at the LEDs. In another embodiment as illustrated in FIG. 3G a return signal and sense signal can be input into the driver for an instance where current sensing is not performed within the driver.

In one embodiment the control module can send digital signals to the driver module which is configured to switch the drive signal to the light-emitting elements on and off in response to the signals received from the control module, wherein this switching can be performed using pulse width modulation (PWM), pulse code modulation (PCM), or other digital switching protocol, wherein the on time of the light-emitting elements can be varied. Since the driver module maintains a constant current through the light-emitting elements while they are on, the peak current remains the same while the average current or average power through the light-emitting elements is varied. Hence the intensity of the output light is directly proportional to the on time or duty cycle of the switching signal. This dimming method can provide a means for minimizing wavelength shift. As the peak wavelength of a light-emitting element can be strongly influenced by the junction temperature, the thermal management system associated with the lighting module can be configured to prevent excessive junction temperatures from arising, even during periods when the light-emitting elements are being driven at higher than typical current levels. Large changes in peak current, even for the same average power, or junction temperature, may cause noticeable wavelength shifts. Therefore by maintaining the same peak current while changing the average current can assist in ensuring that there is reduced peak wavelength shift over the full dimming range, thereby improving the ability of the drive and control system to maintain a given chromaticity.

In another embodiment the control module can send digital signals to the driver module, wherein the driver module is configured to convert these digital signals into analog drive signals for transmission to the light-emitting elements, wherein this conversion can be performed by a digital-to-analog converter.

In one embodiment the digital signals transmitted to the light-emitting elements are transmitted at a desired frequency in order to eliminate visible flicker from the generated illumination and to ensure a desired level of resolution at low duty cycles which may be required to maintain control of the output intensity and chromaticity. In another embodiment of the system, the control module may send more than one control input to each driver module, wherein this secondary signal may be used to adjust the peak current level which the driver module sends to the light-emitting elements thereby providing a means to improve the resolution at low dimming levels.

In one embodiment of the present invention, the electronic components of the driver module and control module are mounted on a common circuit board such as polyimide or polyester laminates. In another embodiment, the electronic components of the driver module and control module are mounted on separate single or multilayer circuit boards that are electrically and mechanically interconnected via one or more flexible layers. These configurations of the circuit board or boards for the driver module and control module electronic components may be positioned within the lighting module in order to provide a potentially desirable small form factor and/or to facilitate the dissipation of heat generated by the driver module and control module electronic components.

In one embodiment of the present invention, the drive and control system 20 receives input signals from and responds to external devices via communications port 100, wherein these external devices may include occupancy sensors, timers, daylight sensors, infrared communications sensors, optical communications sensors, wireless communications modules, building management systems, lighting network routers and bridges, data communications network routers and bridges, personal computers, and user interfaces, for example. The responses to these received input signals may include scheduled lighting control sequences, on/off and dimming and control and/or colour changing, occupancy sensor responses, load shedding, daylight harvesting, emergency lighting responses, status and fault reporting, and system and/or component lifetime information reporting.

In another embodiment of the present invention, the maximum drive current supplied to the light-emitting elements is initially less than the manufacturer's rated maximum current. The maximum drive current is then slowly increased over the lifetime of the light-emitting elements (which may be on the order of tens of thousands of hours) so as to compensate for device aging and consequent lamp lumen depreciation, until the maximum drive current is equal to the manufacturer's rated drive current at the estimated end-of-life of the light-emitting elements.

In one embodiment of the present invention, as the lighting module comprises a thermal management system the drive and control system can be configured to operate the light-emitting elements beyond a manufacturer's maximum rated current, for example the light-emitting elements can be overdriven, in order to increase the luminous flux output of the lighting module, when required. The thermal management system provides a means for effectively transferring heat away from the light-emitting elements, thereby providing a means the light-emitting elements to be overdriven without reducing the longevity or operational characteristics of the light-emitting elements due to thermal considerations.

Feedback System

The lighting module further comprises a feedback system for collecting and forwarding operational characteristics of the lighting module to the drive and control system, thereby enabling modification of the operational characteristics to meet predetermined criteria. The operational characteristics can include lighting or illumination characteristics, thermal characteristics, and/or other characteristics as required. The feedback system within the lighting module can comprise one or more forms of detectors or other feedback-type devices. For example, an optical sensor and/or thermal sensor can be integrated into the feedback system. The optical sensor can detect and provide information to the drive and control system that relates to the radiant flux and chromaticity of the light-emitting elements in addition to ambient daylight readings, for example. This information can enable the drive and control system to modify the activation of the light-emitting elements within the lighting module in order that a desired illumination is generated. For example, this form of feedback can enable the lighting module to maintain a desired illumination level and colour, and may further enable compensation for ambient light conditions. The feedback system can be configured to enable the drive and control system to react with sufficient speed and stability in order that changes in the light level or colour cannot be detected visually by an observer. In one embodiment, the feedback system can operate at a sampling frequency of greater than or equal to about 250 Hz.

Feedback can also be provided by thermal sensors that detect the temperature of the substrate or circuit board on which the light-emitting elements are mounted, the temperature of one or more of the light-emitting elements, and the temperature within the lighting module itself, for example. This information can be transferred to the drive and control system, thereby enabling the modification of the activation of the light-emitting elements in order to prevent thermal damage of the light-emitting elements due to overheating, for example thereby improving the longevity thereof. Furthermore, through the monitoring of temperature, control of the operation of the lighting module can be performed in a manner that results in temperature-insensitive operation such that the desired illumination level and colour are maintained within predefined limits regardless of the temperature, wherein this temperature can be the ambient temperature or a temperature measured within the lighting module.

In one embodiment of the present invention, a thermal sensor is configured to monitor the temperature of the one or more optical sensors. In this manner the variations in the light detection characteristics of the one or more optical sensors due to temperature variations can be compensated for by the drive and control system. This compensation of the optical sensors temperature dependence may provide a means for the lighting module to generate and maintain desired illumination characteristics in an effective and efficient manner.

The feedback system can comprise one or more sensors with the required circuitry, wherein the collected information is subsequently transmitted to the drive and control system. In one embodiment, one or more optical sensors are positioned geometrically in order to optimize the reception of adequate illumination for appropriate operation of the optical sensor. Furthermore the one or more optical sensors can be interfaced with appropriate circuitry in order to condition and/or amplify the signals generated by the optical sensors, as required. The circuitry interfaced with the one or more optical sensors can additionally provide a means for providing one or both of signal gain control and modification of an integration time constant.

In one embodiment and having particular regard to the collection of optical characteristics of the light generated by the light source, the light-emitting elements forming the light source are grouped into two or more clusters of one or more light-emitting elements with the clusters arranged such that a portion of the light emitted from each cluster is directly incident upon a central axis, wherein every point along the central axis is equidistant from each cluster. The light-emitting elements within each cluster are typically placed close to each other relative to the distance between each cluster. The path length of the light from each light-emitting element incident on each point along the central axis is thus approximately equal for all the light-emitting elements. One or more optical sensors also having a central axis associated therewith are positioned such that the central axis of the clusters and the central axis of the optical sensor coincide. In this manner a substantially equal optical path length from each cluster to the optical sensor is provided and can ensure that substantially an equal portion of light from each cluster is incident upon the optical sensor.

In one embodiment of the present invention, the feedback system comprises a plurality of filtered optical sensors with associated colour filters, for example silicon photodiodes with dyed plastic filters, to measure the chromaticity and intensity of the illumination generated by the lighting module. Thin-film interference filters and polymer optical interference filters based on giant birefringent optics (GBO) as described for example by R. Strharsky and J. Wheatley in “Polymer Optical Interference Filters,” Optics & Photonics New, November 2002, pp. 34-40, may also be used, as may planar dielectric waveguide gratings as described for example by R. Magnusson and S. Wang, 1992, “New Principles for Optical Filters,” Applied Physics Letters 61(9): 1002-1024 and S. Peng and G. M. Morris, 1996, “Experimental Demonstration of Resonant Anomalies in Diffraction from Two-Dimensional Gratings,” Optics Letters 21(8):549-551. Each colour filter can for example exhibit spectral bandpass characteristics that limit the response of an optical sensor to a predetermined range of wavelengths of visible light, such as for example red, green, and blue. In a further embodiment, the temperature of the filtered optical sensors is monitored so that possible temperature-dependent changes in the optical filter spectral absorption characteristics (such as is known to occur with thin-film interference filters) can be estimated. This thermal monitoring of the optical sensor can enable compensation of the temperature dependence thereof. Appropriate circuitry can also be incorporated in the optical sensor in order to filter out any unwanted noise and additionally provide amplification of optical sensor signals as required.

In one embodiment of the present invention, a single optical sensor is used to monitor each of the light-emitting elements individually for their contribution to the total light output of the lighting module. In this embodiment, a polling sequence can be used in order to collect illumination contributions of each of the light-emitting elements individually, through for example sequential activation of each light-emitting element individually.

In another embodiment of the present invention, a plurality of optical sensors is used to monitor a single light-emitting element or group thereof.

In one embodiment of the present invention, a light-emitting element, when in a deactivated state can be used to measure the intensity and chromaticity of the light incident thereupon thereby providing another means for illumination detection.

In another embodiment an optical sensor can comprise a linear array of light detectors that act as a spectroradiometer, thereby enabling a more complete representation of the illumination. This optical sensor can provide a means for the drive and control system to more accurately control the light-emitting elements, as it provides both intensity and chromaticity information.

In one embodiment the temperature sensor is a thermistor, thermocouple, semiconductor diode, or transistor with a known temperature dependency curve, thereby enabling collection of a temperature feedback signal. In addition, temperature feedback relating to the operation of the lighting module can be derived from the forward voltage of the one or more light-emitting elements or other known parameters that vary with temperature, for example the peak wavelength of a light-emitting element.

In one embodiment of the present invention, the feedback system comprises a proportional-integral-derivative (PID) controller to accept sensor inputs and provide feedback signals to the drive and control system in such a manner as to maintain constant luminous flux output and chromaticity, and to minimize visually perceptible undershoot or overshoot of luminous flux output and chromaticity in response to changes in the feedback signals.

In another embodiment of the present invention, the feedback system includes a trainable neural network such as is described in United States Patent Application Publication No. 2005/0062446, “Control System for an Illumination Device Incorporating Discrete Light Sources,” to linearize the feedback sensor signals prior to their input to the PID controller. In this embodiment the feedback system comprises a computing means for receiving the information from one or more sensors and determining control parameters based on a multivariate function having a solution defining the hyperplane representing constant luminous intensity and chromaticity. Under these conditions the computing means can essentially linearise the information from the one or more sensors, thereby determining a number of control parameters from the input information, for transmission to the drive and control system. The drive and control system can subsequently determine the control signals to be sent to the light-emitting elements in order to control the illumination produced thereby.

Thermal Management System

The lighting module further comprises a thermal management system for the removal of heat generated by the light-emitting elements. The thermal management system comprises intimate thermal contact with the light-emitting elements and provides a predefined thermal path for the heat to be transferred away from the light-emitting elements. The thermal path has a low thermal resistance along the transference pathways and contacts between these pathways and the light-emitting elements.

Passive Cooling

In one embodiment of the present invention, the thermal management system comprises one or more heat pipes. A heat pipe has a condenser end and an evaporator end, wherein the condenser end may attach to a heat sink, or other heat removal or dissipation device, which enables the transfer of heat to a medium external to the lighting module. The evaporator end is in thermal contact with the light-emitting elements. The light-emitting elements can be in direct physical contact with the evaporator end of the heat pipe or may optionally be mounted on a thermally conductive substrate, for example a metal core printed circuit board (MCPCB) or a thermally conductive substrate with conductive metallic traces applied thereupon, wherein the substrate is in direct contact with the evaporator end of the heat pipe. The working fluid associated with the heat pipe, wherein the working fluid transfers the heat from the evaporator end to the condenser end of the heat pipe, can be selected from a variety of fluids including water and other suitable liquids, for example, as would be readily understood. In addition, the one or more heat pipes can be designed with a specific shape, length and working fluid for a desired application of the lighting module.

In one embodiment, one or more heat sinks are thermally connected to the one or more heat pipes along their length.

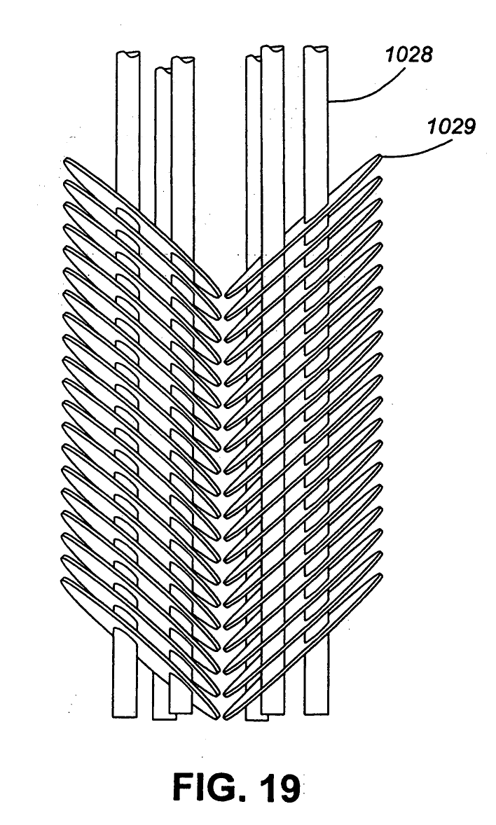

FIG. 19 illustrates one embodiment of the thermal management system wherein the heat pipes 1028 are thermally connected to a heat sink 1029 comprising a plurality of fins which are positioned in an angled orientation relative to the length of the heat pipes. The angle of the connection between the fins and the heat pipe may provide a means for improvement of the movement of air though the heat sink relative to fins mounted perpendicular to the longitudinal direction of the heat pipes.

In one embodiment the thermal resistance of the contact location between a heat pipe evaporator end and the substrate can be minimized using a thermally conductive material such as thermal grease, solder or thermally-conductive epoxy. Furthermore, the evaporator end of the heat pipe can be shaped, polished or machined to increase the contact area between the heat pipe and the substrate, thereby improving thermal conductivity there between. In addition, the substrate on which the light-emitting elements are mounted can be constructed of a thin, highly thermally conductive material, for example chemical vapor deposition (CVD) diamond, aluminum nitride ceramic, beryllium oxide ceramic, alumina ceramic, copper and polyimide, silicon or silicon carbide. The attachment of the light-emitting elements to the substrate can be made in a manner so as to substantially maximize thermal conductivity therebetween. In this embodiment, the evaporator of the heat pipe can be integrated into the substrate, submount or package upon which the light-emitting elements are mounted.

In another embodiment of the present invention, the thermal management system comprises a thermosyphon device. A thermosyphon transfers heat away from the light-emitting elements using an evaporator/condenser scheme similar to a heat pipe as previously described, but wherein the evaporator and condenser are connected by a continuous loop for fluid and vapor flow. In this embodiment the evaporator of the thermosyphon can be integrated into the substrate upon which the light-emitting elements are mounted.

Active Cooling

In one embodiment of the present invention, the thermal management system comprises a Peltier-effect thermoelectric cooling device or thermotunneling cooling device as disclosed in for example U.S. Pat. No. 6,876,123 that can be attached to, or integrated into, the substrate upon which the light-emitting elements are mounted. A thermoelectric device is a solid-state device that, upon application of an electric bias, would enable heat transfer from the light-emitting elements to a thermal pathway that can be defined by a heat pipe or thermosyphon, for example. In this embodiment, a heat pipe or thermosyphon can be thermally connected to the hot side of the thermoelectric or thermotunneling device.

In another embodiment the thermal management system includes a thermionic device as described for example in A. Shakouri and J. E. Bowers, 1997, “Heterostructure Integrated Thermionic Coolers,” Applied Physics Letters 71(9):1234-1236, which is attached to, or integrated into, the substrate upon which the light-emitting elements are mounted. In a thermionic device, the application of an electric bias can provide a means for heat to flow away from one surface, for example the substrate.

In another embodiment the thermal management system comprises a fluid cooling system, for example water or cooling oil, that is pumped through a heat exchanger that is attached to, or integrated into, the substrate upon which the light-emitting elements are mounted. The fluid can act as a thermal pathway and transfer heat to another heat exchanger, for subsequent transfer to an external medium, for example ambient air. Alternatively, the fluid can be pumped over any or all of the surfaces of the light-emitting elements using a mechanical pump or a microfluidic pump.

In one embodiment of the present invention, the external medium to which heat is transferred by the thermal management system is a fluid readily available to the lighting module. For example in some configurations, an air-conditioning system or a water system may be proximate to the lighting module and therefore the thermal management system can be configured to enable transfer of the heat to this external system, as an alternative to ambient air.

In another embodiment the thermal management system comprises a fan or other mechanical device for enabling airflow in order to enhance thermal transfer and dissipation.

Optical System

The optical system provides a means for efficient light extraction and efficient optical manipulation of the emission of the light source. The optical system can provide a means for the extraction and collection of radiation, collimation of the emission and mixing of the spectral content of-the emission from multiple light-emitting elements, for example. The optical system can also provide control over the spatial distribution of light emanating from the lighting module. In addition, the optical system can provide a means for directing a fraction of the emission to an optical sensor and may additionally block ambient light from the optical sensor in order to enable generation of feedback relating to the lighting module's output illumination characteristics.

The optical system can be designed to provide characteristics including any one or more of optimal collection efficiency of the illumination emitted by the light source, minimal losses in the optics, beam collimation with low residual divergence or a closely-matched Lambertian beam profile, optimal colour mixing within a short optical path length, and geometrically-controllable luminous distribution without undesired spatial luminous intensity or chromaticity variations.

The optical system can use a variety of optical elements to produce a desired luminous intensity and chromaticity distribution. The optical elements can include one or more of refractive elements, for example glass or plastic lenses, compound parabolic concentrators (CPC) or advanced modifications thereof such as tailored dielectric total internal reflection optics, Fresnel lenses, GRIN lenses and microlens arrays. The optical elements can also include reflective and diffractive elements, including holographic diffusers and GBO-based mirrors.

In one embodiment the lighting module can comprise a set of submodules. In this configuration the optical system can be divided into primary optics to collect and manipulate the emission of the light-emitting elements of a submodule and secondary optics to manipulate the output of each submodule and thereby further shape the output of the lighting module. Optionally, secondary optics may not be required if the primary optics provide desired manipulation of the emitted luminous flux. Providing primary and secondary optical elements can enable multiple manipulation stages of the illumination generated by the light-emitting elements of the lighting module, thereby enabling the creation of a desired illumination pattern. In one embodiment the primary optics are configured to perform light extraction and collimation and the secondary optics are configured to perform light mixing. It would be readily understood that the primary and secondary optics can perform any desired manipulation of the light generated by the light source.

In one embodiment light-emitting elements of RGB or RGBA or white or a combination of white and colour light-emitting elements are closely packed and encapsulated in encapsulation material that enhances light extraction. An optic to enhance the light extraction, such as a dome lens can be placed in close proximity to the light-emitting elements. A reflective optic such as a tapered hollow light pipe can collimate and mix the light emission. It is understood that the optic can take different sectional shapes such as a parabola or a collection of tailored multi segmented straight lines. Optionally a final optic such as a convex glass lens, Fresnel lens or a more complex lens can aid in shaping the beam output of such a submodule. A secondary optic such as a holographic diffuser can be placed over the submodule to modify the luminous distribution of the single submodule or an arrangement of multiple submodules.

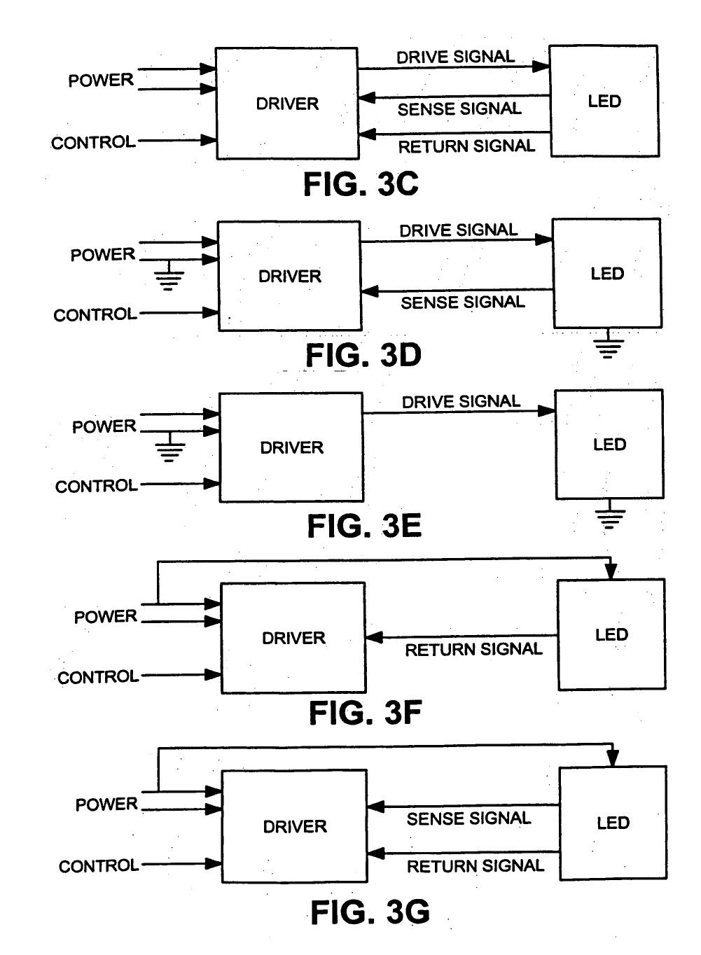

In one embodiment of the present invention, a dielectric total internal reflection concentrator (DTIRC) such as a CPC optical element can be used to collect the emission from a multiplicity of light-emitting elements. As an example, a square array of four light-emitting elements can form the light source for the lighting module or submodule, and the optical system can be a segmented CPC arranged in a cloverleaf pattern in order to achieve a desired collection efficiency. FIG. 4 illustrates a cross section of a segmented CPC optic element 140 in proximity of two light-emitting elements 142. It is readily understood that the sectional shape of the concentrator is not limited to parabolic, but can also take the shape for example of a hyperbola, ellipse, trumpet, or a connection of many line segments wherein each segment is designed to meet the optical purpose desired.

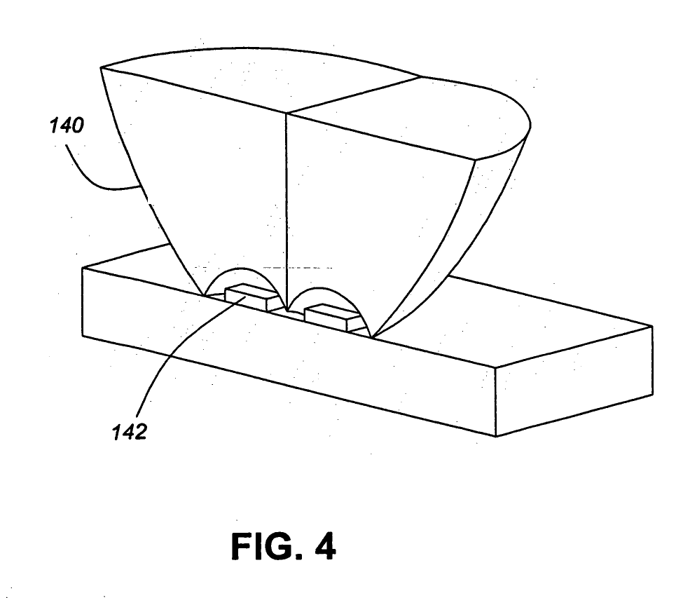

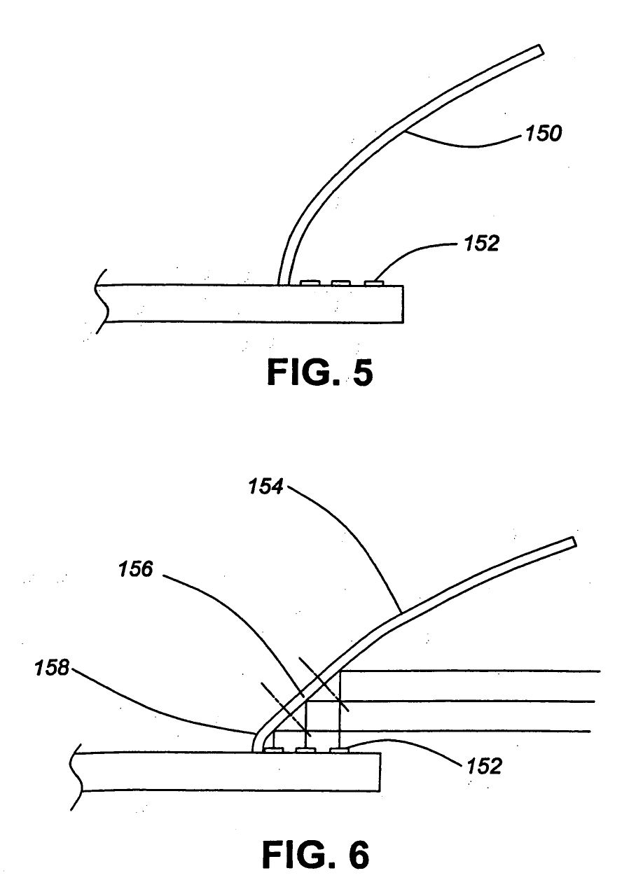

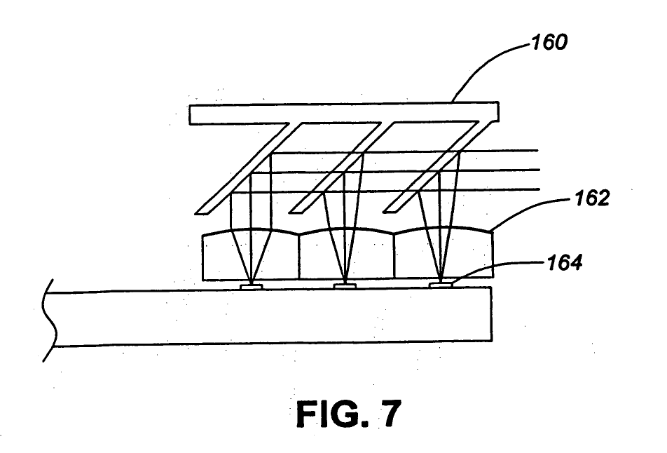

In a set of embodiments of the present invention, the optical system comprises a structure having multiple partially reflective surfaces used to redirect, colour mix and if required collimate the emission of a plurality of light-emitting elements, for example a RGBA configuration of light-emitting elements. FIG. 5 illustrates a sectional view of a two dimensional arrangement of light-emitting elements wherein a parabolic reflector 150 is positioned proximate to the light-emitting elements 152. FIG. 6 illustrates a segmented parabolic reflector comprising three segments 154, 156 and 158 positioned proximate to the light-emitting elements 152, also in a sectional view of a two dimensional arrangement. FIG. 7 shows a microlens array 162 and dichroic reflector/filter assembly 160 that can provide collimation of the emissions from the light-emitting elements 164. The reflective surfaces illustrated in FIG. 7 are flat however they can be any shape required, for example the reflective surfaces can optionally be parabolic or elliptical. These reflective surfaces can be selectively transmissive, for example they can be transmissive to the illumination entering the rear of the reflector, but reflective to the illumination generated by the light-emitting elements they face.

In one embodiment, an optical element of the optical system can have the shape of a cup or half cup for example. This form of configuration can be envisioned by rotating the 2 dimensional section views illustrated in FIG. 5, 6 or 7 around an axis parallel and in proximity to the location of the light-emitting elements. For example this rotation around a defined axis would be 360° for a cup shaped optical element and 180° for a half cup shaped optical element. In an alternate embodiment, an optical element can have the shape of a cone or half cone by rotating the 2 dimensional sectional views illustrated in FIGS. 5, 6 and 7 around an axis parallel and distant to the light-emitting elements, by 360° and 180°, respectively. In another embodiment, the optical element can take the shape of a linear optical element having a cross sectional view as illustrated in FIGS. 5, 6 and 7. Other forms of optical elements would be readily understood by a worker skilled in the art.

In another embodiment, the optical system comprises a plurality of microlenses or an array of microlenses that are designed to either redirect the emissions of the light-emitting elements or a subset thereof to a common point, or optionally create a collimated illumination output.

In another embodiment the optical system comprises a diffractive optical element (DOE) that is used as a primary optic to create a desired luminous intensity distribution from the light-emitting elements. The DOE employs diffraction to alter the path of light incident thereupon, and can be combined with further optics to manipulate the luminous distribution generated by the lighting module.

In another embodiment, the optical system comprises a photonic crystal structure such as is described in for example S. Fan, P. R. Villeneuve, J. D. Joannopoulos, and E. F. Schubert, 1997, “Photonic Crystal Light Emitting Diodes,” SPIE Vol. 3002, pp. 67-73, and which when directly placed or deposited onto the light-emitting element that can be designed to enhance the emission of the light-emitting element by reducing the level of total internal reflection within the light-emitting element, and which may further manipulate the luminous intensity distribution of the light-emitting element.

In another embodiment of the present invention, the optical system can comprise secondary optics wherein the secondary optics can be a DOE used to further modify the luminous intensity distribution. Furthermore the secondary optics can optionally be randomly oriented diffractive multigrating structures that exhibit iridescence over wide viewing angles, as described for example by T.-H. Wong, M. C. Gupta, B. Robins, and T. L. Levendusky, 2003, “Colour Generation in Butterfly Wings and Fabrication of Such Structures,” Optics Letters 28(23):2342-2344.

In a further embodiment the optical system comprises secondary optics which include one, multiple or a combination of reflective optical elements and/or refractive optical elements and/or diffractive optical elements. For example, reflective optical elements can include parabolic reflectors or elliptical reflectors. Refractive optical elements can include Fresnel lenses, regular plano-convex, biconvex, concave-convex lenses and diffractive optical elements can include holographic and kinoform diffusers, for example.

In a further embodiment of the present invention, an optical element of the optical system can be designed to enable the geometrical luminous distribution of the lighting module to be dynamically controlled by the drive and control system or an external operator. Optical properties of the optical system can be changeable in a number of ways. The light-emitting elements can be combined with fluid lenses such as are disclosed in for example U.S. Pat. No. 2,062,468, featuring electrostatically adjustable focus capabilities, or liquid crystal lenses. The application of an electric field upon the fluid lens causes the curvature of the lens to change and in turn alters the focal length. Upon application of an inhomogeneous electrical field on the liquid crystal material, a gradient index profile can be created which in turn enables an alteration of the focal length of the controllable optical system. Optionally, the optical system can comprise a means for mechanically adjusting the one or more optical elements therein, thereby providing a means for dynamic alteration of the level of manipulation of the illumination performed by the optical system.

In one embodiment of the present invention, a function of the optical system is to provide a sampling of the illumination generated by the light-emitting elements to an optical sensor or array thereof, in order for emission characteristics to be fed back to the drive and control system. In one embodiment the optical system comprises an optical element to reflect or transmit a portion of the illumination emitted by the light-emitting elements onto an optical sensor or array of optical sensors. This optical element can optionally be coupled to a form of light guide enabling the guiding of the illumination to the optical sensors.

In one embodiment a rod-like structure is mounted on top of a sensor or sensors providing optical feedback of the luminous intensity and spectral distribution of the illumination. The surface of the rod can be patterned to preferentially admit illumination from proximate light-emitting elements and absorb or reflect illumination from other directions. Illumination admitted to the interior of the rod-like structure can be preferentially conducted towards the optical sensor or sensors. In another embodiment, the rod-like structure can be connected to or be part of a final optic or window associated with the optical system. In this configuration the rod provides a means for funneling by means of total internal reflection or Fresnel reflections, some of the emissions that are trapped in the optic to an optical sensor or sensor array. In another embodiment one or more optical elements can be designed to leak a desired amount of emission of the light-emitting elements from one or more predefined locations. The predefined locations can be selected in order that the leaked emissions are either directly incident to an optical sensor or sensor array or are selected such that the leaked emissions of each submodule are guided through a hollow or solid light guide onto the optical sensor or sensor array. Such a light guide can include a mixing chamber in which contributions from all submodules are mixed.

In one embodiment of the present invention, the optical system is designed so as to diffuse the direct view of the light-emitting elements such that their luminances are within the industry-standard thresholds established for eye safety.

Communication System

In one embodiment of the present invention the lighting module comprises a communication module that provides a means for the drive and control system to communicate with a network of other said lighting modules and other controlling devices external to the lighting module. The communications system can enable the lighting module to interface to a network and can enable data transfer using a range of prior art data transmission media and data transfer protocols as would be known to one skilled in the art. Such data transmission media can be for example, Ethernet, fibre optic, wireless, or infrared communication systems. Examples of suitable protocols, depending on communications needs, include analog 0-10 VDC, Digital Addressable Lighting Interface (DALI), ESTA protocols including DMX512A, RDM, and ACN, IEEE 802.11 wireless protocols including Bluetooth and Zigbee, infrared protocols including IrDA and Ultra Fast Infrared (UFIR), or any other protocol as would be readily understood.

The communication system can provide a means for the operation of the lighting module in an integrated manner amongst an array of other such lighting modules. Each lighting module can have a communication system and associated data transfer capability and can be further integrated into a communications network connecting the array of lighting modules. For example the transfer of data related to radiant flux of the light-emitting elements, daylight and/or ambient colour temperature, lighting module and board temperature thereby enabling the array of lighting modules to operate in a unified manner.

In one embodiment of the invention the communication system can enable the drive and control system to transmit or receive data via one or a plurality of physical communication formats including hardware serial or parallel bus, fibre optic receiver or transceiver, wireless receiver or transceiver, infrared receiver or transmitter, or visible light receiver. The network topology can be selected from bus, star, token ring, mesh, or wireless for example. Alternate network topologies would be readily understood by a worker skilled in the art.

In one embodiment of the present invention, the communication system enables a network physical layer selected from those including hardwired, fibre optic, wireless, infrared or visible light for example. In another embodiment the communication system enables a network comprising visible light transmitters and receivers wherein the transmitters are light-emitting elements and wherein the luminous flux output of light-emitting elements is modulated with serial data.

In one embodiment of the present invention other controlling devices external to the lighting module may include occupancy sensors, daylight sensors, timers, other lighting networks, and building management systems.

The invention will now be described with reference to specific examples. It will be understood that the following examples are intended to describe embodiments of the invention and are not intended to limit the invention in any way.

### EXAMPLES

### Example 1

FIG. 8 illustrates a first example of the present invention integrated into a multi-lighting module quad flat pack (QFP) package. The lighting unit comprises a plurality of light-emitting elements 300 which also includes proximate optical elements. The reflector optic 310 manipulates the emissions from the light-emitting elements in a desired direction that may subsequently interact with a secondary optic 320, if this secondary optical is provided. In one embodiment this secondary optic can be a snap-on type optic thereby enabling ease of removal and inclusion of this optic. The light-emitting elements can be mounted on a CVD diamond substrate 370 through the use of a thermally conductive adhesive thereby enabling thermal conductivity there through. In direct thermal contact to the CVD diamond substrate is a heat pipe 360 which can be held in a desired position by a housing 350. The heat pipe(s) can enable transfer of heat generated by the light-emitting elements away therefrom. Furthermore the lighting unit comprises a substrate 340 which for example can be manufactured from FR4, which is a woven glass reinforced epoxy resin or alternately a MCPCB if desired. Upon the substrate 340 can be mounted electronic components 330 including a controller, feedback system and other desired electronic devices. Traces on the substrate 340 can provide a means for the interconnection between the light-emitting elements and the controller or other electrical devices as would be required, for example. In this example, a sensor that forms a portion of the feedback system can be mounted within close proximity of the light-emitting elements, for example proximate to one or more light-emitting elements within each reflector optic. Optionally a sensor can be positioned on the substrate 340 wherein the optical system can provides a means for directing a portion of the emission from the light-emitting elements thereto.

### Example 2

FIG. 9 illustrates a second example of the present invention formed as a modular lighting unit torchiere. The light-emitting elements 210 are mounted on a thermally conductive substrate 290 that is also thermally bonded to a heat pipe 220, thereby enabling heat transfer from the light-emitting elements to the heat pipe for subsequent dissipation. The ends of the heat pipe are in contact with the housing 250 which may comprise slits 280 therein enabling the flow of air within the housing thereby providing an additional means for heat dissipation. Positioned below and in operative contact with the light-emitting elements in a PC board 240 including a drive and control system mounted thereon, wherein this PC board can be operatively connected to a power supply 260, for example. Furthermore the emissions from the light-emitting elements can be manipulated by an optical diffuser 230.

### Example 3

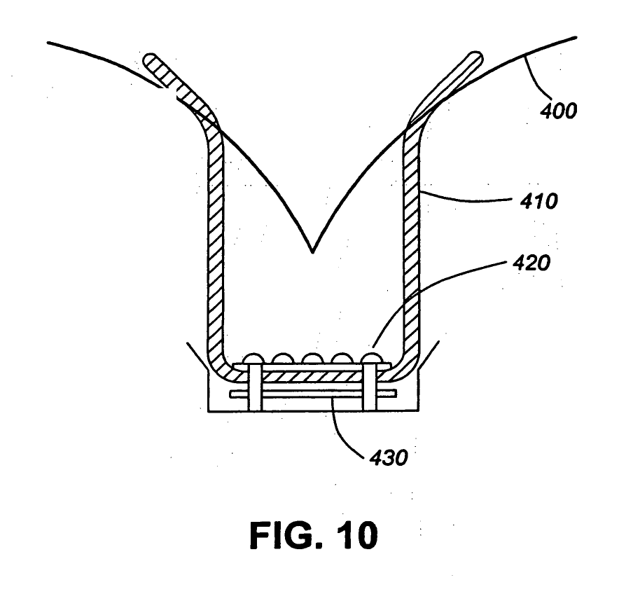

FIG. 10 illustrates a third example of the present invention formed as a modular lighting unit luminaire wherein the light-emitting elements 420 are mounted on a substrate or a heat pipe 410 or optionally the light-emitting elements can be directly mounted to the sidewall of the heat pipe. Positioned below the heat pipe and operatively connected to the light-emitting elements is a control board 430. A diffuser/reflector 400 is provided to enable manipulation of the emissions of the light-emitting elements.

### Example 4

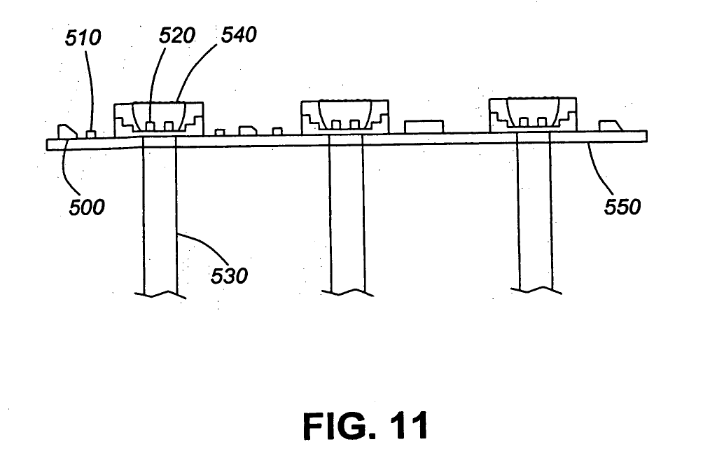

FIG. 11 illustrates a lighting unit that comprises multiple sub-modules interconnected together. Each sub-module comprises light-emitting elements 520, an optical element 540 and a heat pipe 530 in intimate thermal contact with the light-emitting elements. The sub-modules can be coupled together by a PC board upon which other electronic components 500 and 510 that can include electronic devices providing drive, control and feedback to one or more of the sub-modules, can be mounted. For example, each sub-module can comprise one or more light-emitting elements that can enable the creation of white light. The light-emitting elements can include monochromatic, polychromatic or broadband wavelength emission light-emitting elements or a combination thereof. In addition the light-emitting elements can include primary or secondary light-emitting elements, wherein secondary light-emitting elements can be phosphor-coated LEDs or quantum dot LEDs.

### Example 5

FIG. 12 illustrates cross section of a lighting unit wherein the lighting and electronic components are designed in a stacked formation. Within the housing 630 of the lighting unit is positioned, in a stacked configuration, the power supply, drive, feedback, control and other required electronics on the PC boards 640, 650 and 660. There may optionally be a fewer or greater number of PC boards depending on the required electronics. These PC boards can be in thermal contact with one or more heat pipes 670, which can provide a means for transferring heat from the PC boards to a heat sink 680 or other heat dissipation system, for example. In this manner the PC boards may be more closely positioned due to the thermal regulation provided by the heat pipe or other thermal management system, thereby enabling a smaller lighting unit to be manufactured. The heat pipe additionally is in intimate thermal contact with one or more light-emitting elements 620 that can enable the removal of heat created thereby. In addition the emissions of the light-emitting elements can be manipulated by an optical element 600 positioned proximate to the light-emitting elements. A light and/or thermal sensor 610 can be positioned proximate to the light-emitting elements thereby enabling the collection of information relating to the chromaticity of the emissions in addition to the junction temperatures of the light-emitting elements. The lighting-emitting elements and the one or more sensors can be mounted on a FR4 board or MCPCB for example. The PC boards, the light-emitting elements and the one or more sensors are operatively connected to each other in a manner that provides each of these elements their desired functionality.

### Example 6

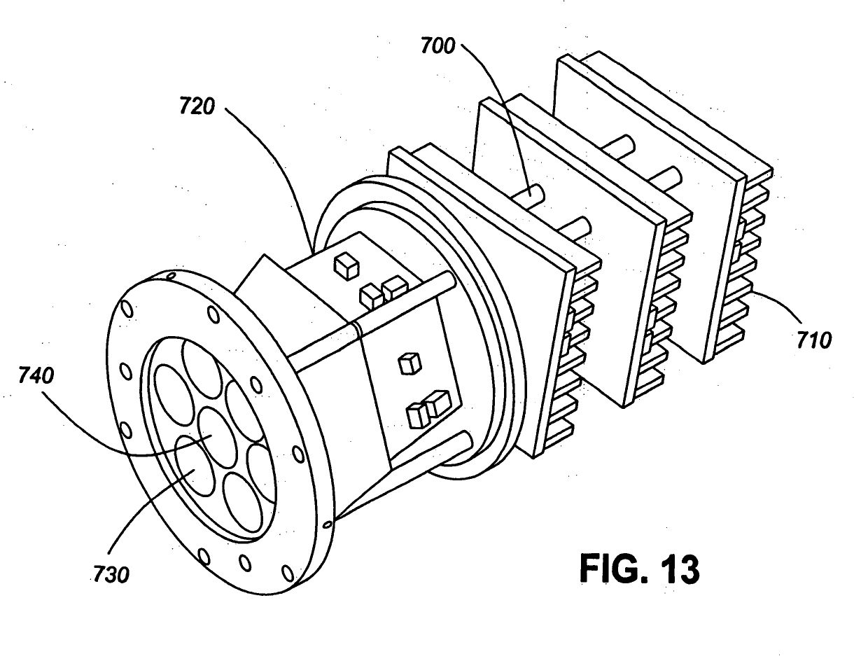

FIG. 13 is a photograph of a lighting module according to one embodiment of the present invention. The light-emitting elements and optics are formed into clusters 730 wherein these clusters are thermally connected to one or more heat pipes 700. The heat transferred by the heat pipes is dissipated using multiple heat sinks 710 formed as finned heat sinks in order to enhance heat dissipation. An optical feedback system 740 is positioned relative to the multiple clusters in such a manner as to provide optical characteristics of the illumination generated by the multiple light-emitting elements. Required electronic components for the operation of the light module are mounted on a plurality of PCB boards 720. These required electronic components includes the drive and control system.

### Example 7

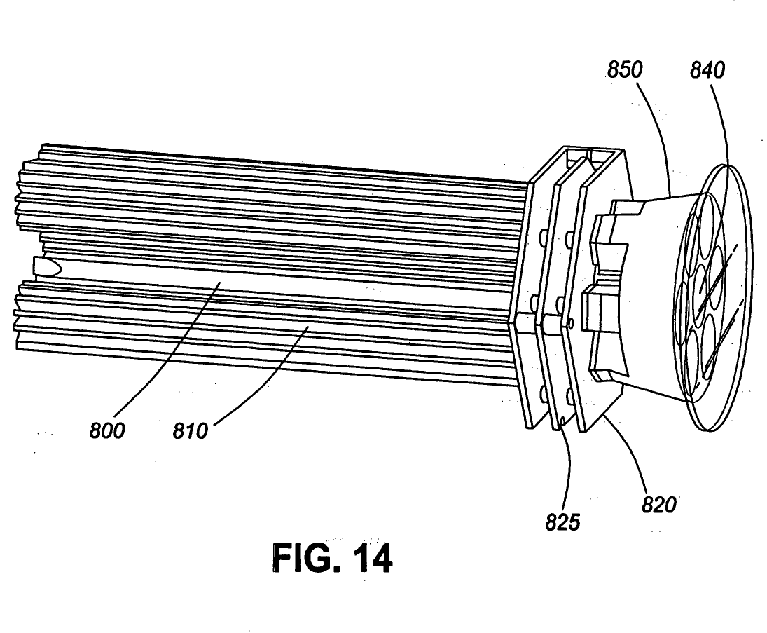

FIG. 14 is a lighting module according to another embodiment of the present invention. This embodiment of the lighting module is configured similar to that illustrated in FIG. 13, wherein the light-emitting elements and optical system 850 are formed as clusters wherein these light-emitting elements these clusters are thermally connected to a plurality of heat pipes 800. The heat pipes pass through the PCB boards in order to make thermal contact with the clusters of light-emitting elements. The heat transferred by the heat pipes is dissipated using multiple heat sinks 810 which are designed in the form of sleeves. A heat sink sleeve surrounds the perimeter of a heat pipe wherein thermal contact therebetween can be enhanced using a thermal grease or other material. The heat sink sleeve can have fins along its length in order to enhance heat dissipation thereby. An optical feedback system 840 is positioned relative to the multiple clusters of light-emitting elements in such a manner as to provide optical characteristics of the illumination generated by the multiple light-emitting elements. Required electronic components for operation of the light module are mounted on PCB board 825 and the light-emitting elements together with the sensor system are mounted on PCB board 820. In one embodiment, wherein the drive and control system is formed for a control module and a drive module, the drive module and controller module can be mounted on different PCBs. For example, the control module can be mounted on PCB board 820 and the driver module can be mounted on PCB board 825. The

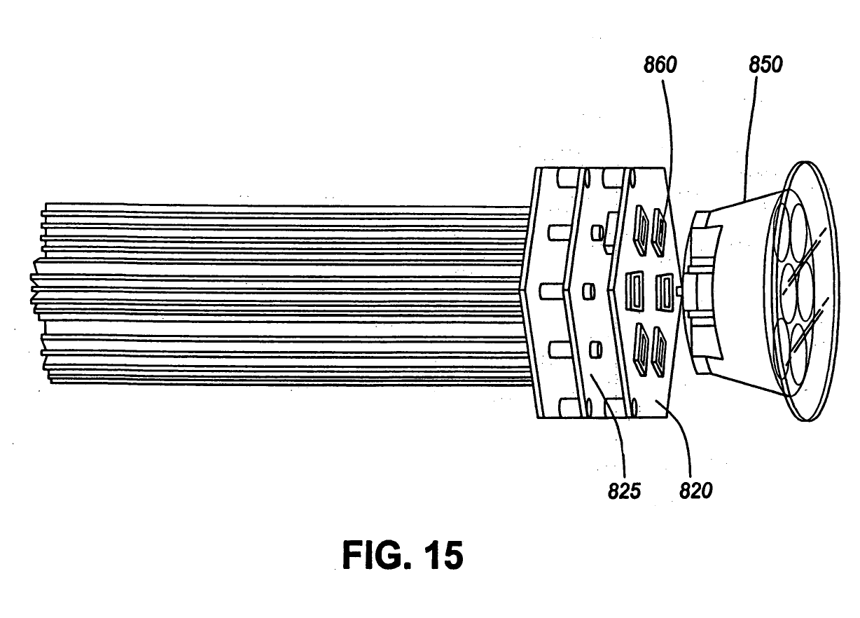

FIG. 15 illustrates the embodiment of FIG. 14, wherein the optical system 850 has been separated from the light module thereby exposing the groups of light-emitting elements 860 mounted on PCB board 820.

The embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### Example 8

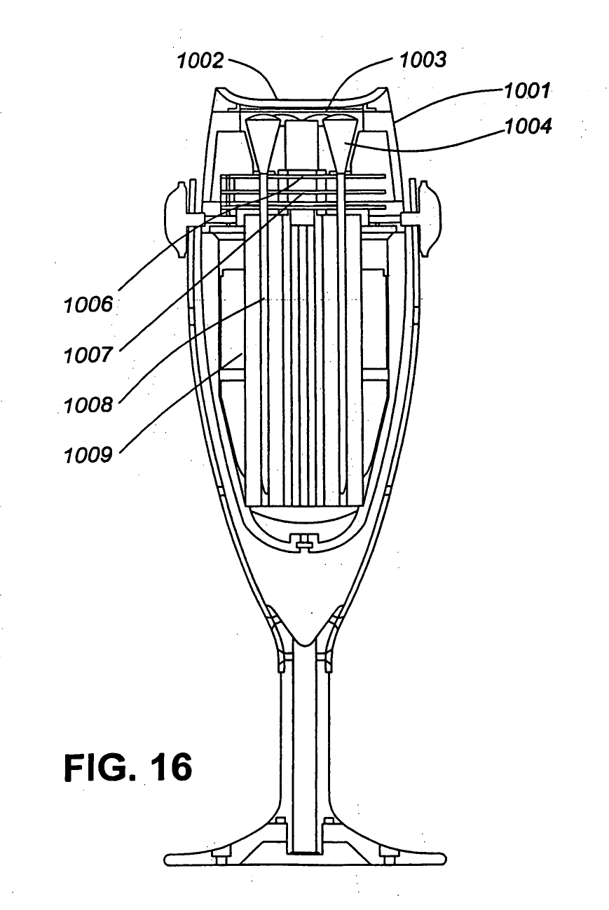

FIG. 16 illustrates a lighting module according to one embodiment of the present invention as it may be mounted within a shaped housing 1001. The optical system comprises a quadertiary optic 1002, a tertiary optic 1003 for collimating the light, a secondary optic 1004 configured as a conical pipe for mixing the light, wherein the primary optic is positioned proximate to the light-emitting elements and the primary optic is configured to enhance light extraction from the light-emitting elements.

The substrate upon which the light-emitting elements are mounted is designed to be highly thermally conductive and configured to interface with the heat pipe 1008 to provide a means for efficient heat transfer away from the light-emitting elements. The heat pipes are thermally connected to a heat sink 1009 which provides a means for dissipation of the heat to the environment, for example the ambient air.

The LED PCB 1006 has mounted thereon the control module, one or more sensors and communication system which are all configured for communication with the light-emitting elements. In addition the driver PCB 1007 has mounted thereon the drive module which is in operation communication with the control module.

### Example 9

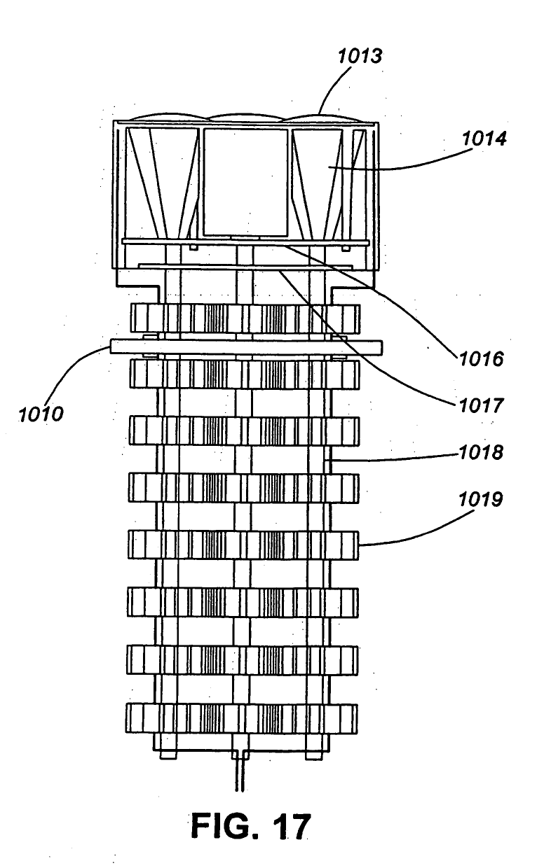

FIG. 17 illustrates a lighting module according to one embodiment of the present invention. The optical system comprises a tertiary optic 1013 for collimating the light, a secondary optic 1014 configured as a hexagonal tapered pipe for mixing the light, wherein the primary optic is positioned proximate to the light-emitting elements and the primary optic is configured to enhance light extraction from the light-emitting elements.

The substrate upon which the light-emitting elements are mounted is designed to be highly thermally conductive and configured to interface with the heat pipe 1018 to provide a means for efficient heat transfer away from the light-emitting elements. The heat pipes are thermally connected to a heat sink 1019 which provides a means for dissipation of the heat to the environment, for example the ambient air.

The LED PCB 1016 has mounted thereon the control module, one or more sensors and communication system which are all configured for communication with the light-emitting elements. The substrate upon which the light-emitting elements are mounted is inferiorly mounted to the LED PCB, wherein a hole is located at the location of the light-emitting elements. In addition the driver PCB 1017 has mounted thereon the drive module which is in operation communication with the control module.

A mounting pin 1010 can be mechanically connected to the lighting module and can provide a means for mechanical connection between the lighting module and a housing.

### Example 10

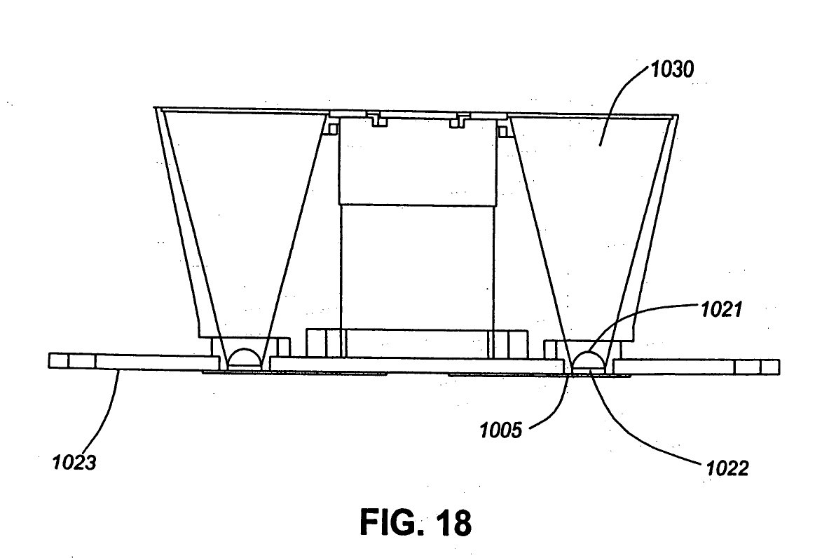

FIG. 18 illustrates an optical system according to one embodiment of the present invention. The optical system comprises a secondary optic 1030 configured as a concial pipe for mixing the light, wherein the primary optic 1021 is positioned proximate to the light-emitting elements and the primary optic is configured to enhance light extraction from the light-emitting elements.

The substrate upon which the light-emitting elements are mounted is designed to be highly thermally conductive and configured to interface with a heat pipe to provide a means for efficient heat transfer away from the light-emitting elements.

The LED PCB 1023 has mounted thereon the control module, one or more sensors and communication system which are all configured for communication with the light-emitting elements. The substrate 1005 upon which the light-emitting elements are mounted is inferiorly mounted to the LED PCB, wherein a hole is located at the location of the light-emitting elements.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

1. An integrated lighting module comprising:
(a) one or more light-emitting elements for generating illumination;
(b) an optical system optically coupled to the one or more light-emitting elements for manipulating the illumination;
(c) a feedback system for collecting information representative of operational characteristics of the one or more light-emitting elements, said feedback system generating one or more signals representative of said information, the feedback system includes one or more optical sensors configured to generate signals representative of the illumination generated by the one or more light-emitting elements, the optical system comprises an optical element for capturing and directing a portion of the illumination to the one or more optical sensors, said signals representative of any one or more characteristics selected from the group comprising illumination colour, illumination correlated colour temperature and illumination intensity;
(d) a thermal management system in thermal contact with the one or more light-emitting elements, said thermal management system for conducting heat away from the one or more light-emitting elements;
(e) a drive and control system receiving the one or more signals from the feedback system, said drive and control system regulating input power and generating and sending control signals to the one or more light-emitting elements, said control signals generated based on predetermined control parameters and said one or more signals.

2. The integrated lighting module according to claim 1, wherein the thermal management system includes one or more heat pipes, each heat pipe having an evaporator end.

3. The integrated lighting module according to claim 2, wherein the one or more heat pipes are physically connected to one or more of the one or more light-emitting elements.

4. The integrated lighting module according to claim 2, wherein the one or more light-emitting elements are mounted on a thermally conductive substrate and wherein the one or more heat pipes are in direct thermal contact with the thermally conductive substrate.

5. The integrated lighting module according to claim 4, wherein the evaporator end of one of the one or more heat pipes is integrated into the thermally conductive substrate.

6. The integrated lighting module according to claim 1, wherein the thermal management system comprises one or more thermal devices selected from the group comprising a Peltier-effect thermoelectric cooling device, a thermionic device, and a fluid cooling system.

7. The integrated lighting module according to claim 2, wherein the thermal management system further comprises one or more heat sinks thermally connected to the one or more heat pipes, said one or more heat sinks for dissipating the heat transferred thereto by the one or more heat pipes.

8. (canceled)

9. The integrated lighting module according to claim 1, wherein the feedback system includes one or more temperature sensors configured to generate signals representative of operational temperature of the one or more light-emitting elements.

10. The integrated lighting module according to claim 1, wherein the feedback system further comprises a temperature sensor configured to generate signals representative of operational temperature of the one or more optical sensors.

11. The integrated lighting module according to claim 1, wherein one or more of the one or more optical sensors are further configured to generate signals representative of ambient light conditions.

12. The integrated lighting module according to claim 1, wherein the one or more optical sensors include a colour filter, said colour filter for limiting optical sensor response to a predetermined range of wavelengths.

13. The integrated lighting module according to claim 1, wherein the one or more optical sensors are interfaced with circuitry adapted to manipulate the signals generated by the one or more optical sensors, wherein manipulation of the signals includes one or more of signal conditioning, signal amplification, gain control and integration time control.

14. The integrated lighting module according to claim 1, wherein the one or more light-emitting elements are electrically connected for individual control thereof by the drive and control system.

15. The integrated lighting module according to claim 1, wherein the one or more light-emitting elements emit light having a colour selected from the group comprising: white, red, green, blue, cyan and amber.

16. The integrated lighting module according to claim 1, wherein the drive and control system digitally controls the one or more light-emitting elements using either pulse width modulation or pulse code modulation.

17. The integrated lighting module according to claim 1, wherein the drive and control system includes a switching converter operatively coupled to selected light-emitting elements of the one or more light-emitting elements, said switching converter providing a means for regulating current to the selected light-emitting elements based on a detected voltage drop across the selected light-emitting elements.

18. The integrated lighting module according to claim 1, wherein the drive and control system and the one or more light-emitting elements are mounted on a common thermally conductive substrate, wherein the thermal management system further provides a means for conducting heat away from the drive and control system.

19. The integrated lighting module according to claim 1, wherein the drive and control system is operatively connected to a user interface thereby providing a means for a user to modify the illumination generated by the integrated lighting module.

20. The integrated lighting module according to claim 1, wherein the optical system includes one or more optical elements configured to manipulate the illumination from the one or more light-emitting elements, wherein manipulation includes one or more of light extraction, light collection, light collimation and light mixing.

21. (canceled)

22. The integrated lighting module according to claim 1, further comprising a communication system operatively connected to the drive and control system, said communication system enabling one or both of data input to the lighting module or data output from the lighting module.

23. (canceled)
